(19) United States
(12) Patent Application Publication
(10) Pub. No.: US 2026/0330939 A1
(43) Pub. Date: Oct. 22, 2026

(54) DOOR ALARM SYSTEM

(71) Applicant: Total Lock & Security, Inc., St. Louis, MO (US)

(72) Inventors: James P. Mitchell, St. Louis, MO (US); Chris Carron, Ste. Genevieve, MO (US)

(21) Appl. No.: 19/648,394

(22) Filed: Apr. 15, 2026

Related U.S. Application Data
(60) Provisional application No. 63/789,811, filed on Apr. 16, 2025.

(51) Int. Cl. G08B 13/08; G08B 13/22

(52) U.S. Cl. CPC G08B 13/08; G08B 13/22

(57) ABSTRACT

A sensor assembly for a door alarm system includes a plurality of anchors for securing a sensing actuator to a mounting bracket. The plurality of anchors include a first anchor located proximate a first bracket end for securing a first end of the sensing actuator, a second anchor located proximate the second bracket end for securing a second end of the sensing actuator, and a reinforcing anchor positioned between the first and second bracket ends. The plurality of anchors allow movement of the sensing actuator in the first direction while limiting movement of the sensing actuator in a second direction different from the first direction. In some embodiments, the plurality of anchors can limit bowing, bending, or warping in the sensing actuator in use and/or during installation.

### CROSS-REFERENCE TO RELATED APPLICATION

This application claims priority to U.S. Provisional Application No. 63/789,811, filed Apr. 16, 2025, the disclosure of which is hereby incorporated herein by reference in its entirety.

### TECHNICAL FIELD

The present disclosure relates generally to door alarms. More particularly, the present disclosure relates to door alarms that can generate alarms or alerts in response to a detected overhead condition of the door.

### BACKGROUND

It is not uncommon for patients in, for example, psychiatric hospitals, to attempt to commit suicide. Patient rooms are typically cleared of most items with which patients can commit suicide. For example, patients do not wear belts. One way in which patients do attempt to commit suicide is to tie a knot in the end of a bed sheet, drape the bed sheet over the top of a door (either the door to the patient's room or the bathroom door in the patient's room), and close the door. The knot on the end of the bed sheet will prevent the sheet from sliding through the closed door, and the patient can then hang himself or herself with the sheet.

U.S. Reissue Pat. Nos. RE42991, dated Dec. 6, 2011, and RE44039, dated Mar. 5, 2013, describe door alarm systems that activate an alarm when a door is closed with something (e.g., a sheet, cord, or the like) over the top of the door. A sensing element, such as a pressure-sensitive switch, can be mounted proximate or on the top of the door and extends substantially the full width of the door. When the sensing element is triggered, e.g., via downward pressure on the sensing element, a signal can be transmitted to activate the alarm such that appropriate personnel is alerted.

There is an ongoing need to improve the integrity and rigidity of the sensing elements used in door alarm systems to prevent tampering with or damage to the sensing element and to prevent alarm failure without sacrificing the sensitivity of the sensing element for detecting items that may be positioned over the top of the door.

### SUMMARY

The present disclosure provides a sensor assembly for a door alarm system that includes a sensing actuator and a plurality of anchors for securing the sensing actuator to a mounting bracket. The sensing actuator and the mounting bracket may be mounted at or on the top of the door for detecting overhead conditions of the door, such as items that may be positioned over the top of the door when it is closed. The sensing actuator is pressure sensitive and can move relative to the mounting bracket in a first direction in response to downward pressure or loads to detect items positioned over the top of the closed door. The sensing actuator and the mounting bracket preferably extend substantially the full width of a door when installed and the sensing actuator may be an elongate member such as a rod that has the propensity to bow, bend, or warp along its length if not properly secured. The plurality of anchors are provided to secure the sensing actuator to limit the risk of such bowing, bending, or warping and provide structural integrity to the sensing actuator during use and/or installation, while allowing movement of the sensing actuator in the first direction such that the sensing actuator can trigger an alarm. The plurality of anchors can also limit movement of the sensing actuator in directions other than the first direction to limit or prevent tampering with the sensing actuator. In some embodiments, the plurality of anchors include a first anchor located proximate a first bracket end for securing a first end of the sensing actuator, a second anchor located proximate the second bracket end for securing a second end of the sensing actuator, and a reinforcing anchor positioned between the first and second bracket ends. One or more reinforcing anchors can be used. The reinforcing anchor(s) preferably include a structurally rigid anchoring bracket that supports portion(s) of the sensing actuator between its ends to limit movement in a direction other than the first direction and/or limit bowing, bending, or warping of the sensing actuator.

The following description and the appended figures set forth certain features for purposes of illustration. Advantages will become more apparent when reading the present disclosure in its entirety.

### BRIEF DESCRIPTION OF DRAWINGS

So that the above-recited features may be understood in detail, a more particular description, briefly summarized above, may be had by reference to example aspects, some of which are illustrated in the appended drawings.

FIG. 1 depicts a door equipped with a door alarm system.

FIG. 2 is a magnified view of encircled area 2 in FIG. 1.

FIG. 3 is a magnified view of encircled area 3 in FIG. 1.

FIG. 4 is a perspective of a sensor assembly for the door alarm system of FIG. 1.

FIG. 5 is a magnified view of encircled area 5 in FIG. 4.

FIG. 6 is the magnified view of FIG. 5 with an anchor shown exploded.

FIG. 7 is a magnified view of encircled area 7 in FIG. 4.

FIG. 8 is the magnified view of FIG. 7 with an anchor shown exploded.

FIG. 9 is a magnified view of encircled area 9 in FIG. 4.

FIG. 10 is a sensing actuator of the sensor assembly of FIG. 4.

FIG. 11 is a magnified view showing segment ends of the sensing actuator exploded relative to a reinforcing anchor.

FIG. 12 is a perspective of another sensor assembly for the door alarm system of FIG. 1.

FIG. 13 is a magnified view of encircled area 13 in FIG. 12.

FIG. 14 is an isolated, magnified view of a reinforcing anchor of the sensor assembly of FIG. 12 movably connected to a structural support member of a mounting bracket.

FIG. 15 is an exploded view showing a pin that facilitates the movable connection between the reinforcing anchor and the structural support member of FIG. 14.

Corresponding reference numbers in the drawings indicate corresponding parts.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

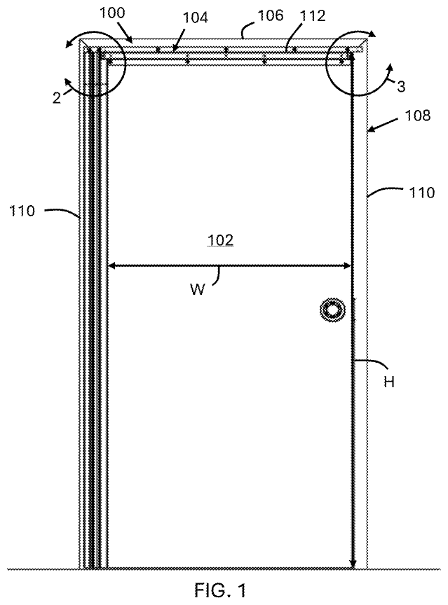

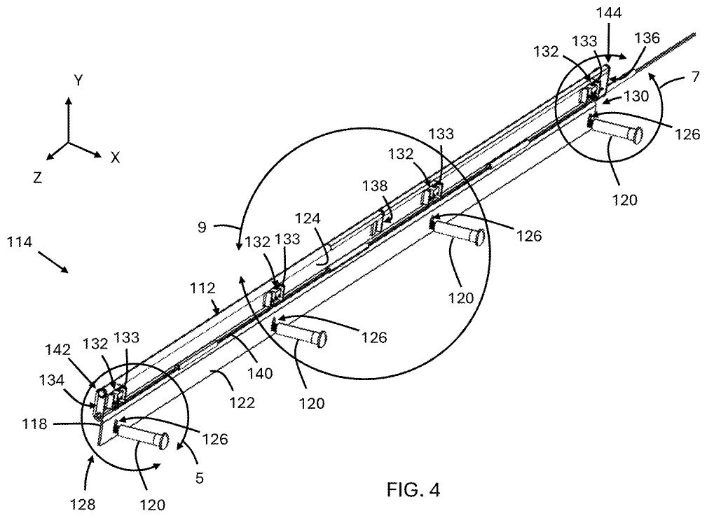

Referring to FIG. 1, a door alarm system 100 for a door 102 is shown. The door alarm system 100 may be operable to detect overhead conditions of the door 102 when the door is closed. For example, the door alarm system 100 can detect items that may be hung over a top 104 of the door 102 and/or items that may be wedged between the top of the door and an overhead frame header 106. In some embodiments, the door alarm system 100 can detect whether a sheet, cord, or other item that can be used to commit suicide is positioned between the top 104 of the door 102 and the frame header 106. The door alarm system 100 may include a sensing actuator 112 that is sensitive to loads or downward pressure at or on the top 104 of the door 102 and can trigger an alarm or alert in response to such loads or pressure. The door alarm system 100 is preferably equipped with anchors (described below with respect to FIG. 4) that can maintain the pressure sensitivity of the sensing actuator 112 while limiting or preventing damage to or tampering with the sensing actuator 112. For example, the anchors may allow the sensing actuator 112 to move vertically in response to loads or downward pressure while limiting bowing, bending, or warping in the sensing actuator in use and/or during installation. The reinforcing anchors may additionally or alternatively limit horizontal and/or lateral movement of the sensing actuator 112 to hinder or prevent tampering with the sensing actuator. Such tampering may include, for example, wedging objects to prevent the sensing actuator 112 from moving in response to loads.

The door 102 may be movably connected to a door frame 108, e.g., via one or more hinges, that allow the door 102 to move or swing relative to the door frame for opening and closing the door. The door frame 108 is positioned on a wall (not shown) and defines a door opening (not shown) in the wall that is accessible when the door is open and substantially inaccessible when the door is closed. The door frame 108 includes the frame header 106 and jambs 110 extending downwardly from the frame header 106 toward the floor (not shown). The jambs 110 are positioned on opposite sides of the door opening. The door 102 may be connected to one of the jambs 110, e.g., via one or more hinges. The door 102 may include a locking mechanism, e.g., a handle and lock, that engages the other jamb 110 when the door is closed. A width W of the door 102 may be substantially equal to a width of the door opening between the jambs 110. A height H of the door 102 may be slightly shorter than a height of the door opening between the frame header 106 and the floor such that a small gap exists between the top 104 of the door and the frame header 106.

In some embodiments, in addition to the features described herein, the door alarm system 100 can incorporate features of the door alarm systems described in U.S. RE42991 and U.S. RE44039, which are each hereby incorporated herein by reference in their entirety.

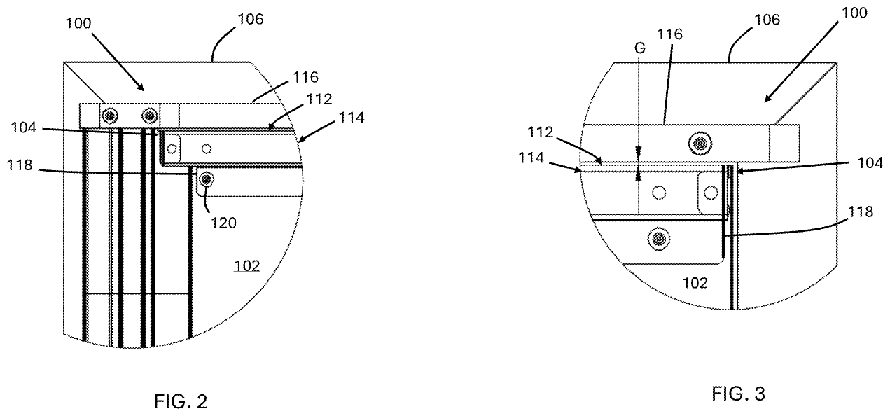

Referring to FIG. 2, the door alarm system 100 may include a sensor assembly 114 mounted proximate or on the top 104 of the door 102 and a header bar 116 mounted on the frame header 106. The header bar 116 may be mounted on the frame header 106 using any suitable means, such as fasteners, adhesive, welding, bonding, or the like, or combinations thereof. The header bar 116 may be positioned substantially flush with a bottom of the frame header 106. The header bar 116 may cooperate with the sensor assembly 114 for detecting overhead conditions of the door 102 when the door is closed. For example, the door alarm system 100 can detect items positioned between the sensor assembly 114 and the header bar 116 which may be indicative of items hung over the top 104 of the door 102 and/or wedged between the top of the door and the frame header 106. In some embodiments, the header bar 116 may be omitted and the sensor assembly 114 may cooperate with the frame header 106 for detecting overhead conditions of the door 102, e.g., by detecting items positioned between the sensor assembly 114 and the frame header 106.

The sensor assembly 114 may include the sensing actuator 112 and a mounting bracket 118. Each of the sensing actuator 112 and the mounting bracket 118 may extend substantially the full width W of the door 102 between the jambs. The mounting bracket 118 may be mounted on the door 102 using any suitable means, such as fasteners, adhesive, welding, bonding, or the like, or combinations thereof. In this embodiment, the mounting bracket 118 may be mounted on the door 102 using fasteners 120, such as bolts for example. The mounting bracket 118 may be positioned substantially flush with or slightly below the top 104 of the door 102.

The sensing actuator 112 may be movable vertically relative to the mounting bracket 118. In some embodiments, the sensing actuator 112 may be movable vertically between an inactive position and an active position. The sensing actuator 112 may be biased toward the inactive position. When the sensing actuator 112 is in the inactive position, the sensing actuator may be positioned at least partially above the mounting bracket 118.

As shown in FIG. 3, a gap G may be defined between the sensing actuator 112 and the header bar 116 (and/or the frame header 106 in some embodiments). The gap G may be smaller than the gap between the top 104 of the door 102 and the frame header 106 when the sensing actuator 112 is in the inactive position. In some embodiments, when the sensing actuator 112 is in the inactive position, the gap G may be infinitesimal such that the sensing actuator 112 slightly contacts the header bar 116. Any contact between the sensing actuator 112 and the header bar 116 preferably does not cause the sensing actuator 112 to move to the active position without an external item positioned between the sensing actuator and the header bar.

The sensing actuator 112 may be pressure sensitive and can move toward the active position when a load or downward pressure is applied at or near the top 104 of the door 102. For example, the sensing actuator 112 may move toward the active position when an item (e.g., a sheet, cord, or the like) is positioned between the top 104 of the door 102 and the frame header 106. The item may become wedged between the sensing actuator 112 and the header bar 116 (and/or the frame header 106 in some embodiments) such that a downward pressure is applied by the item on the sensing actuator. As the sensing actuator 112 moves toward the active position, the gap G may widen. In some embodiments, movement of the sensing actuator 112 from the inactive position toward the active position can cause the sensor assembly 114 to transmit a signal that triggers an alarm or alert. Preferably, the pressure needed to move the sensing actuator 112 to the active position is relatively low to trigger an alarm signal via the sensor assembly 114 even under relatively light loads. For example, the pressure needed to move the sensing actuator 112 to the active position may be from about 0.5 pounds per square inch (psi) to about 5 psi.

As an illustrative example, if a sheet or similar item is placed at or on the top 104 of the door 102, when the door is closed the sheet may apply a downward pressure that moves the pressure-sensitive actuator 112 toward the active position. In some embodiments, the gap G may be small enough when the actuator 112 is in the inactive position such that even relatively thin items, such as bedsheets, become wedged between the actuator 112 and the header bar 116 to create downward pressure on the actuator. The sensor assembly 114 may transmit a signal in response to movement of the actuator 112 toward the active position that triggers the alarm or alert for notifying personnel of the situation.

The alert or alarm triggered via the sensor assembly 114 is not limited and can take various forms. For example, the sensor assembly 114 may trigger an audible and/or visual alarm or alert. In some embodiments, the alarm or alert can be generated via an alarm device in wired and/or wireless communication with the sensor assembly 114. For example, the alarm device may be hardwired with the sensor assembly 114. Additionally or alternatively, the alarm device may be in wireless communication with the sensor assembly 114 using a transmitter of the sensor assembly in conjunction with a receiver of the alarm device where the alarm or alert can be triggered at the alarm device via the receiver upon detection of a signal from the transmitter. The alarm device can be mounted by the door (e.g., on the outside of a patient's room) so that the alarm or alert can be easily seen and/or heard by hospital personnel when it is activated. Additionally or alternatively, the alarm device can be positioned at a central location (e.g., a nurse's or staff station) so that staff or personnel manning the station will be notified when the alarm or alert is triggered. In some embodiments, the alarm or alert can include an indication of the room from which the alarm or alert is triggered.

Referring to FIG. 4, the mounting bracket 118 may have a “Z-shape” or “S-shape” profile defined by a first or lower portion 122 and a second or upper portion 124 offset from the first portion. The first portion 122 engages a door (e.g., the door 102) when the sensor assembly 114 is installed. The first portion 122 also includes fastener holes 126 that receive the fasteners 120. The first portion 122 may be connected to the door via the fasteners 120 extending through the holes 126 to mount the mounting bracket 118 on the door.

The second portion 124 may be positioned above the first portion 122 when the mounting bracket 118 is mounted on the door. The second portion 124 may be offset from the first portion 122 such that the second portion is spaced from the door 102 when the mounting bracket 118 is mounted. The sensing actuator 112 may be accommodated between the second portion 124 and the door 102. The sensing actuator 112 may be positioned at or proximate a top edge of the second portion 124.

The sensing actuator 112 may include an elongate member, e.g., a rod in this embodiment. The sensing actuator 112 can be a unitary structure or, as described below, may be constructed of multiple segments. The sensing actuator 112 may extend substantially the full width of the mounting bracket 118 between a first end 128 of the mounting bracket and a second end 130 of the mounting bracket. The sensing actuator 112 may be movable relative to the mounting bracket 118 as described above and may be operably coupled with one or more switches 132. The switches 132 may be accommodated between the second portion 124 and the door 102 below the sensing actuator 112.

The switches 132 may generate signals when the sensing actuator 112 moves from the inactive position toward the active position. For example, the sensing actuator 112 moving toward the active position may engage one or more of the switches 132 to close the switch. The switches 132 may include mechanical switches with contacts that are electrically connected with one another in response to engagement between the sensing actuator 112 and the switch. In some embodiments, the switches 132 may include snap-action switches with an engagement element that engages the sensing actuator 112 and, in response, moves contacts into electrical connection with one another. For example, the switches 132 may include lever-type, pushbutton or plunger-type, or roller-type snap action switches, or a combination thereof.

The sensor assembly 114 may include one switch 132 or multiple switches. In some embodiments, the sensor assembly 114 includes multiple switches 132 positioned at spaced apart intervals between the first and second ends 128, 130 of the mounting bracket 118. For example, in the illustrated example of FIG. 4, four switches 132 may be included. The switches 132 may be spaced apart at regular or irregular intervals. In some embodiments, the switches 132 are distributed between the first and second ends 128, 130 to ensure that at least one switch is engaged by the sensing actuator 112 in response to a load on the sensing actuator irrespective of the location of the load along the length of the sensing actuator. In this way, the sensor assembly 114 can trigger an alert or alarm irrespective of the location of the item exerting the load on the sensing actuator 112. Moreover, as described above, the sensing actuator 112 and the mounting bracket 118 extend substantially the full length of the door such that the sensing actuator will be moved by an item irrespective of its location at or on the top of the door. In this way, the sensing actuator 112 will move to engage a switch 132 no matter where an item may be placed between the door and the frame header.

The one or more switches 132 of the sensor assembly 114 may be connected to or mounted on the second portion 124 using any suitable means. For example, the switches 132 can be connected to or mounted on the second portion 124 via fasteners, adhesive, welding, bonding, or the like, or combinations thereof.

The switches 132 can be in wired and/or wireless communication with one or more alarm devices. When one or more of the switches 132 is engaged by the sensing actuator 112, the switches can close and transmit a signal to an alarm device to trigger an alarm or alert. Wiring 140 can be run to each switch 132 between the second portion 124 and the door. The wiring 140 can transmit signals from the switches 132 and/or provide power to the switches.

As described above, the sensing actuator 112 can be biased toward the inactive position. One or more biasing means 133 may be mounted proximate and operably coupled to the sensing actuator 112. The biasing means 133 can include springs, such as flat springs or spring steel. The biasing means 133 may urge the sensing actuator 112 toward the inactive position and can be compressed or may deflect in response to movement of the sensing actuator 112 toward the active position. Preferably, the biasing means 133 does not excessively constrain movement of the sensing actuator 112 toward the active position and allows the sensing actuator 112 to move toward the active position even under relatively light loads, such as loads from about 0.5 psi to about 5 psi.

The sensor assembly 114 may include one or multiple biasing means 133. In some embodiments, a biasing means 133 may be positioned proximate each switch 132. In some embodiments, the sensor assembly 114 includes multiple biasing means 133 positioned at spaced apart intervals between the first and second ends 128, 130 of the mounting bracket 118. The biasing means 133 may be spaced apart at regular or irregular intervals. The biasing means 133 may be connected to or mounted on the second portion 124 using any suitable means. For example, the biasing means 133 can be connected to or mounted on the second portion 124 via fasteners, adhesive, welding, bonding, or the like, or combinations thereof.

The sensor assembly 114 may also include anchors 134, 136, 138 that movably mount, connect, or anchor the sensing actuator 112 relative to the mounting bracket 118. The anchors 134, 136, 138 allow the sensing actuator 112 to move vertically relative to the mounting bracket 118 while limiting lateral and/or horizontal movement of the sensing actuator 112. In this way, the sensing actuator 112 can move in response to loads toward the active position for engaging the switches 132 while limiting or preventing the risk of tampering with the sensing actuator 112. For example, the anchors 134, 136, 138 may limit horizontal and/or lateral movement of the sensing actuator 112 such that items or objects cannot be wedged between the sensing actuator 112 and the mounting bracket 118 and/or the door in an attempt to interfere with or hinder vertical movement of the sensing actuator. The anchors 134, 136, 138 can additionally or alternatively reinforce and stabilize the sensing actuator 112 to limit bowing, bending, or warping in the sensing actuator in use and/or during installation.

Directional terms used to describe the sensor assembly 114 and movement of the sensing actuator 112 such as “vertical,” “horizontal,” “lateral,” and the like are made with reference to the orientation of the sensor assembly 114 when installed on a door. However, the sensor assembly 114 is not limited to any particular orientation. A coordinate system with X, Y, and Z axes is shown in FIG. 4 and can be used as a reference for directional terminology. For example, the X-axis may define a horizontal axis, the Y-axis may define a vertical axis, and the Z-axis may define a lateral axis. The axes, and their relative directions, can also interchangeably be referred to as “first,” “second,” and “third” axes and directions.

A first anchor 134 may be positioned at or proximate the first end 128 of the mounting bracket 118. A first end 142 of the sensing actuator 112 may be movably connected to the mounting bracket 118 at or proximate the first end 128 of the mounting bracket 118 via the first anchor 134. A second anchor 136 may be positioned at or proximate the second end 130 of the mounting bracket 118. A second end 144 of the sensing actuator 112 may be movably connected to the mounting bracket 118 at or proximate the second end 130 of the mounting bracket 118 via the second anchor 136. The first and second anchors 134, 136 may provide support to the sensing actuator 112 at or proximate the ends 142, 144. As described above, the sensing actuator 112 may extend substantially the full width of the door and, as such, the sensing actuator 112 (e.g., an elongate member such as a rod) may be relatively long in length. At least a third anchor 138 is preferably provided to support the sensing actuator 112 along the length between the ends 142, 144. The third anchor 138 limits the sensing actuator from bowing, bending, or warping between the ends 142, 144, provides more stability to the sensing actuator for well-controlled movement in the vertical direction, and/or limits undesired movement of the sensing actuator in the horizontal direction which can otherwise present a risk of damage to or tampering with the sensing actuator.

The third anchor 138 can also be referred to as a reinforcing anchor. In the illustrated embodiment, a single reinforcing anchor 138 is provided and is located generally toward the center of the mounting bracket 118 for supporting a central region of the sensing actuator 112. In some embodiments, multiple reinforcing anchors can be included for supporting the sensing actuator 112 between the ends 142, 144. For example, the sensor assembly 114 may include two, three, four, five, more than five (such as up to ten), or even more than ten reinforcing anchors. The multiple reinforcing anchors can be spaced apart between the ends 128, 130 of the mounting bracket 118 at regular intervals or irregular intervals.

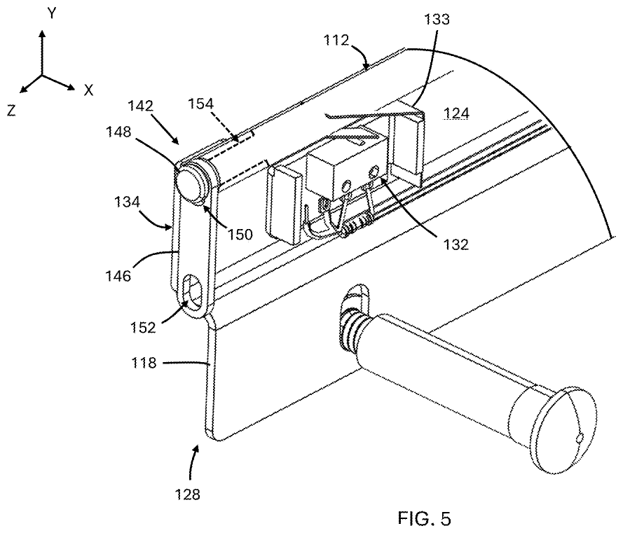

FIG. 5 shows the first anchor 134 supporting the sensing actuator 112 proximate the first end 142. The first anchor 134 includes a rigid anchoring bracket 146 and an anchoring pin 148 that movably connects the first end 142 of the sensing actuator 112 to the anchoring bracket 146. The anchoring bracket 146 may be mounted on the mounting bracket 118 using any suitable means, such as fasteners, adhesive, welding, bonding, or the like, or combinations thereof. In some embodiments, the anchoring bracket 146 may be integrated with the mounting bracket 118. For example, the anchoring bracket 146 may be formed by bending the second portion 124 of the mounting bracket 118 at the first end 128 (e.g., in an L-shape). The anchoring bracket 146 is substantially rigid to limit the anchoring bracket from bending or otherwise allowing lateral or horizontal movement of the sensing actuator 112 proximate the first end 142.

The anchoring bracket 146 may project from the second portion 124 in the horizontal direction. The anchoring bracket 146 may define a lateral end cover for the space between the second portion 124 and the door when the mounting bracket 118 is installed. The anchoring bracket 146 may include a first slot 150 that receives the anchoring pin 148. A second slot 152 of the anchoring bracket 146 may also be provided for wires or cables running to and from the switches 132. The anchoring pin 148 extends through the first slot 150 and connects with the first end 142 of the sensing actuator 112. For example, the anchoring pin 148 can be fastened, threaded, adhered, welded, bonded, etc. to the first end 142 of the sensing actuator 112.

The anchoring pin 148 may be vertically movable in the first slot 150 which allows vertical movement of the first end 142 of the sensing actuator 112 relative to the anchoring bracket 146. For example, the anchoring pin 148 allows the sensing actuator 112 to move between the inactive position (shown in FIG. 5), which the sensing actuator may be biased toward via the biasing means 133 as described above, and the active position in response to loads. Preferably, the anchoring pin 148 cannot substantially move horizontally in the first slot 150 to limit or prevent horizontal movement of the first end 142 of the sensing actuator 112. The first end 142 of the sensing actuator 112 may abut the anchoring bracket 146 to limit or prevent lateral movement of the sensing actuator. To this end, the sensing actuator 112 preferably is dimensioned to prevent the sensing actuator from moving laterally through the first slot 150.

In some embodiments, the sensing actuator 112 may include a reduced diameter portion 154 at the first end 142. The reduced diameter portion is preferably dimensioned to restrict lateral movement of the sensing actuator 112 through the first slot 150 while providing space to accommodate material used to connect the anchoring pin 148 to the sensing actuator 112 at the first end 142. For example, the anchoring pin 148 may be connected to the sensing actuator 112 via welding which can cause material to accumulate at the weld line and the reduced diameter portion 154 may be provided to prevent such accumulated material from interfering with vertical movement of the anchoring pin 148 in the first slot 150.

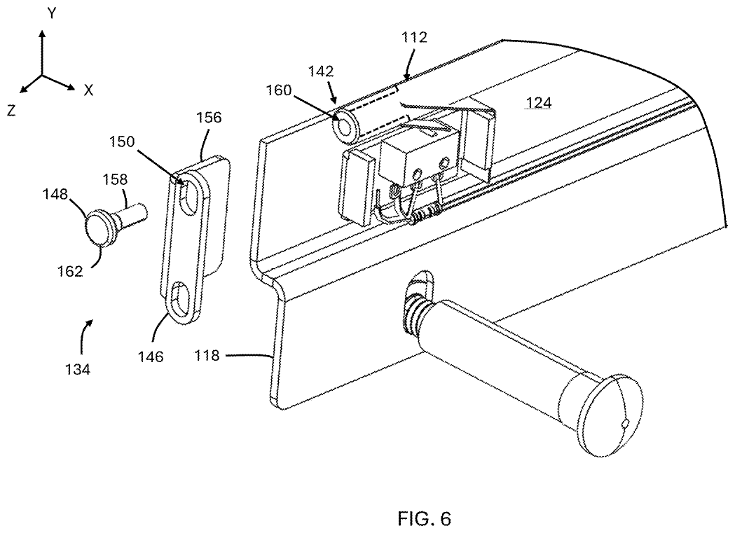

Referring to FIG. 6, the anchoring bracket 146 may be integrated with a tongue 156 that overlaps an outer surface of the second portion 124 of the mounting bracket 118. The tongue 156 may be connected to the second portion 124 using any suitable means, such as fasteners, adhesive, welding, bonding, or the like, or combinations thereof. Alternatively, in embodiments where the anchoring bracket 146 is integrated with the second portion 124 of the mounting bracket 118, the tongue may be omitted.

The anchoring pin 148 may include a tail 158 that extends through the first slot 150 and is received by an opening 160 in the first end 142 of the sensing actuator 112. The tail 158 may partially protrude outward of the opening 160 when the anchoring pin 148 is connected to the sensing actuator 112 and extends through the first slot 150. Preferably, the tail 158 and the first slot 150 are sized to allow vertical movement of the tail in the first slot, and thereby allow vertical movement of the sensing actuator 112, while limiting or preventing horizontal movement of the tail in the first slot, and thereby limiting or preventing horizontal movement of the sensing actuator. For example, the tail 158 may be substantially cylindrical in shape and the first slot 150 may be oval or oblong in shape, where a vertical height of the first slot is sized to allow movement of the sensing actuator 112 between the inactive and active positions, and where a horizontal width of the first slot is approximately equal to a diameter of the tail. The anchoring pin 148 may also include a head 162 or a cap that secures the sensing actuator 112 relative to the bracket 146. The head 162 may laterally abut the bracket 146 to prevent the tail 158 from exiting the first slot 150.

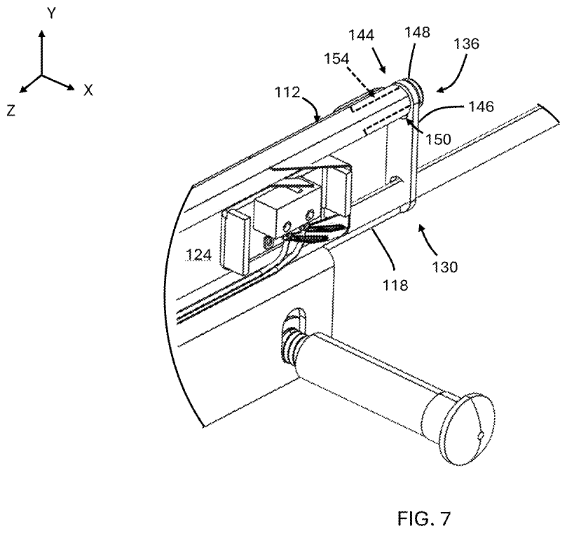

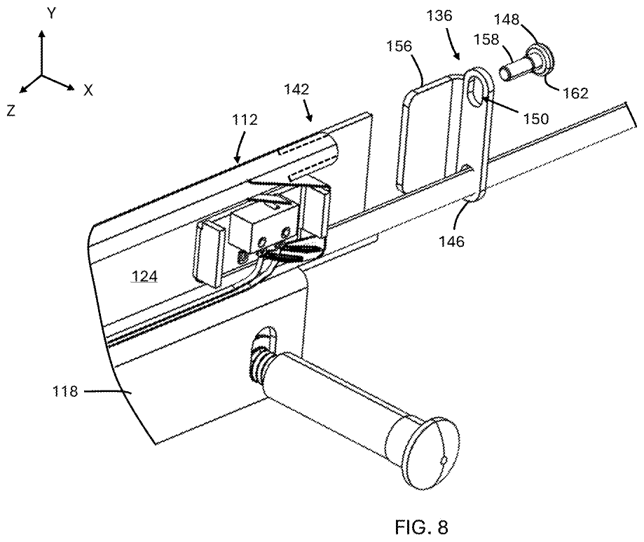

Referring to FIGS. 7 and 8, the second anchor 136 may be constructed similar to the first anchor 134 for supporting the sensing actuator 112 proximate the second end 144 relative to the second end 130 of the mounting bracket 118. The description of the first anchor 134 with respect to FIGS. 5 and 6 may apply equally to the second anchor 136. Similar features between the first anchor 134 and the second anchor 136 may be indicated in FIGS. 5-8 using similar reference numerals. In some embodiments, the sensing actuator 112 may include a reduced diameter portion 154 at the second end 144 similar to the reduced diameter portion described above for the first end 142.

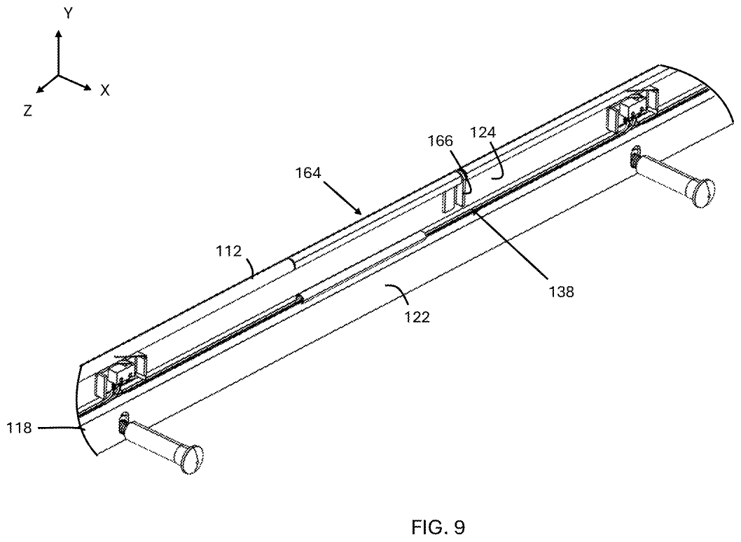

FIG. 9 shows the reinforcing anchor 138 supporting the sensing actuator 112 proximate a central region 164 between the first and second ends 142, 144. The reinforcing anchor 138 includes a rigid anchoring bracket 166. The sensing actuator 112 is connected to the anchoring bracket 166 and is vertically movable relative to the anchoring bracket between the inactive position and the active position. The anchoring bracket 166 is substantially rigid to limit the anchoring bracket from bending or otherwise allowing lateral or horizontal movement of the sensing actuator 112 proximate the central region 164. The rigid anchoring bracket 166 may allow the reinforcing anchor 138 to cooperate with the first and second anchors 134, 136 for providing well-controlled and distributed support for the sensing actuator 112 while also allowing vertical movement of the sensing actuator between the active and inactive positions. In particular, the first and second anchors 134, 136 and the reinforcing anchor 138 can cooperate to limit bowing, bending, or warping at any portion of the sensing actuator along its full length in use and/or during installation. The anchors 134, 136, 138 may additionally or alternatively cooperate to limit horizontal and/or lateral movement at any portion of the sensing actuator 112 along its full length to hinder or prevent tampering with the sensing actuator.

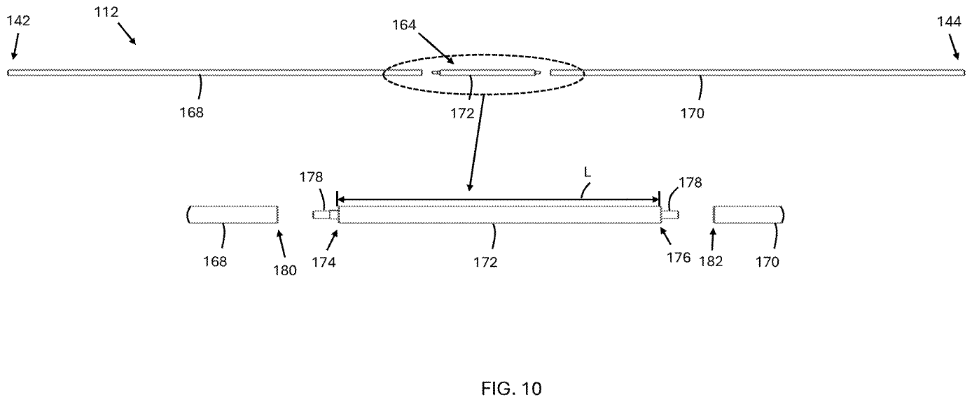

Referring to FIG. 10, the sensing actuator 112 (e.g., an elongate rod) may be segmented to facilitate installing the sensing actuator and connecting the sensing actuator to the reinforcing anchor 138. In this example, the sensing actuator 112 is comprised of three segments 168, 170, 172 but may include more or fewer segments. For example, the sensing actuator 112 may include two, three, four, five, more than five (such as up to ten), or even more than ten segments. A first segment 168 may define the first end 142 of the sensing actuator 112, a second segment 170 defines the second end 144, and a third segment 172 is positioned between the first and second segments 168, 170. The third segment 172 may at least partially define the central region 164 of the sensing actuator 112.

The third segment 172 may extend a segment length L between a first segment end 174 and a second segment end 176. In some embodiments, various third segments 172 having various segment lengths L between the first and second segment ends 174, 176 can be used. The segment length L can vary such that the overall length of the sensing actuator 112 can vary. This may facilitate easier and simpler manufacture of the sensing actuator 112, and the sensor assembly 114, for use with doors having different widths. The segment lengths of the first segment and/or the second segment may also vary for this purpose.

The third segment 172 may include one or more engagement elements 178, such as engagement pins, at each segment end 174, 176. The engagement element 178 at a first segment end 174 of the third segment 172 may engage with a segment end 180 of the first segment 168. The engagement element 178 at a second segment end 176 of the third segment 172 may engage with a segment end 182 of the second segment 170. In the illustrated embodiment, the engagement elements 178 are male elements (e.g., pins) that are received by the corresponding ends 180, 182 of the first and second segments 168, 170. In some embodiments, the engagement elements may be female elements (e.g., holes) that receive male engagement elements (e.g., pins) at the corresponding ends 180, 182 of the first and second segments 168, 170.

The engagement elements 178 may enable connecting the segment ends 174, 176 of the third segment 172 to the first and second segments 168, 170. For example, the engagement elements 178 may engage (e.g., may be received by) the corresponding segment ends 180, 182 of the first and second segments 168, 170 and then the engagement elements 178 can be connected and secured at the corresponding segment ends. In some embodiments, the engagement elements 178 at the segment ends 174, 176 of the third segment 172 can be fastened, threaded, adhered, welded, bonded, etc. to the corresponding segment ends 180, 182 of the first and second segments 168, 170.

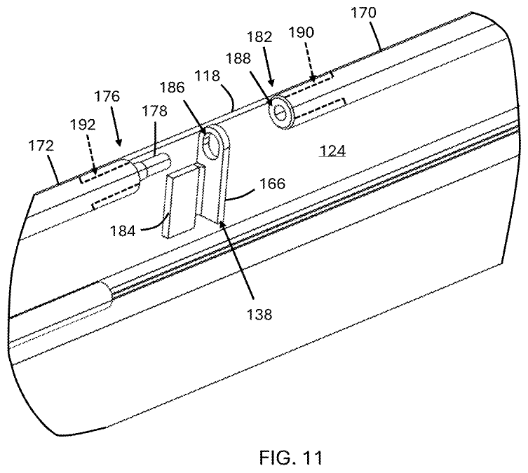

Referring to FIG. 11, the rigid anchoring bracket 166 of a reinforcing anchor 138 may be positioned between the second segment end 176 of the third segment 172 and the segment end 182 of the second segment 170. In some embodiments, the rigid anchoring bracket 166 of a reinforcing anchor 138 may additionally or alternatively be positioned between the first segment end 174 of the third segment 172 and the segment end 180 of the first segment 168. More broadly, the rigid anchoring bracket 166 can be positioned between the segment ends of any adjacent pair of segments of the sensing actuator 112 and used to movably secure the sensing actuator at a segment interface as described below.

The anchoring bracket 166 of the reinforcing anchor 138 may project from the second portion 124 of the mounting bracket 118 in the horizontal direction. The anchoring bracket 166 may be connected to the second portion 124 using any suitable means, such as fasteners, adhesive, welding, bonding, or the like, or combinations thereof. In some embodiments, the anchoring bracket 166 may be joined to a base 184 that is connected to the second portion 124, e.g., via fasteners, adhesive, welding, bonding, or the like, or combinations thereof.

The anchoring bracket 166 defines a slot 186 that receives the male engagement element 178 extending between the segments 170, 172. In this embodiment, a male engagement element 178 (e.g., an engagement pin) may extend from the second segment end 176 of the third segment 172 through the slot 186 and may be received by a female engagement element 188 (e.g., a hole) at the segment end 182 of the second segment 170. In some embodiments, a male engagement element (e.g., an engagement pin) may extend from the segment end 182 of the second segment 170 through the slot 186 and may be received by a female engagement element (e.g., a hole) at the second segment end 176 of the third segment 172.

The male engagement element 178 may be vertically movable in the slot 186 which allows vertical movement of the segments 170, 172 relative to the anchoring bracket 166. In this way, the anchor 138, like the anchors 134, 136, allows the sensing actuator 112 to move vertically relative to the mounting bracket 118. Preferably, the male engagement element 178 cannot substantially move horizontally in the slot 186 to limit or prevent horizontal movement of the segments 170, 172. The ends 182, 176 of the segments 170, 172 may laterally abut the anchoring bracket 166 to limit or prevent lateral movement of the sensing actuator.

In some embodiments, the second segment 170 and/or the third segment 172 may include a reduced diameter portion 190, 192 at the respective end 182, 176. The reduced diameter portions 190, 192 are preferably dimensioned to restrict lateral movement of the respective segment 170, 172 through the slot 186 while providing space to accommodate material used to connect the third segment 172 to the second segment 170. For example, the male engagement element 178 of the third segment 172 may be received by the female engagement element 188 and secured therein via welding which can cause material to accumulate at the weld line. The reduced diameter portion(s) 190, 192 may be provided to prevent such accumulated material from interfering with vertical movement of the male engagement element 178 in the slot 186.

Preferably, the male engagement element 178 and the slot 186 are sized to allow vertical movement of the male engagement element in the slot, and thereby allow vertical movement of the sensing actuator 112, while limiting or preventing horizontal movement of the male engagement element in the slot, and thereby limiting or preventing horizontal movement of the sensing actuator. For example, the male engagement element 178 may be substantially cylindrical in shape and the slot 186 may be oval or oblong in shape, where a vertical height of the slot is sized to allow movement of the sensing actuator 112 between the inactive and active positions, and where a horizontal width of the slot is approximately equal to a diameter of the male engagement element. In some embodiments, the slot 186 and the slots 150 are similarly sized, shaped, and dimensioned.

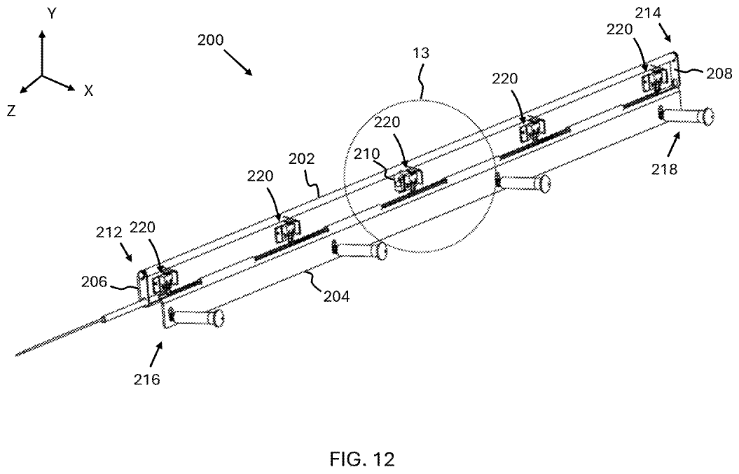

Referring now to FIG. 12, another example of a sensor assembly 200 for the door alarm system 100 of FIG. 1 includes a sensing actuator 202 movably mounted to a mounting bracket 204 via anchors 206, 208, 210. The mounting bracket 204 may be configured similar to the mounting bracket 118 described above, and description of the mounting bracket 118 is applicable to the mounting bracket 204 unless expressly stated otherwise or the context clearly indicates otherwise. The sensing actuator 202 may be similar to the sensing actuator 112, e.g., the sensing actuator 202 may be an elongate member such as a rod. In this embodiment, the sensing actuator 202 may be constructed as a single-piece or unitary sensing actuator (e.g., a single-piece or unitary rod). The sensing actuator 202 may extend, e.g., as a single-piece or unitary rod, between a first end 212 and a second end 214. The first end 212 of the sensing actuator 202 may be positioned proximate a first end 216 of the mounting bracket 204. The second end 214 of the sensing actuator 202 may be positioned proximate a second end 218 of the mounting bracket 204.

The sensing actuator 202, similar to the sensing actuator 112, may be pressure sensitive and can move between an inactive position and an active position in response to a load or downward pressure applied at or near the top 104 of the door 102 (FIG. 1). Movement of the sensing actuator 202 to the active position may cause one or more switches 220 to generate signals, such as alarm signals, via engagement between the sensing actuator 202 and the one or more switches 220. The switches 220 may be configured similar to the switches 132, e.g., the switches 220 may include mechanical switches with contacts that are electrically connected with one another in response to engagement between the sensing actuator 202 and the switch. For example, the switches 220 may include snap-action switches, such as lever-type, pushbutton or plunger-type, or roller type snap action switches, or a combination thereof. One switch 220 or multiple switches 220 may be included; for example, in the illustrated example of FIG. 12, five switches 220 may be included. Description of the functionality, configuration, and other features of the switches 132 above is applicable to the switches 220 unless expressly stated otherwise or the context clearly indicates otherwise.

The sensing actuator 202 may be movably mounted, connected, or anchored to the mounting bracket 204 via the anchors 206, 208, 210. The anchors 206, 208, 210, like the anchors 134, 136, 138 described above, allow the sensing actuator 202 to move vertically relative to the mounting bracket 204 while limiting lateral and/or horizontal movement of the sensing actuator 202, such that the sensing actuator 202 can move in response to loads toward the active position for engaging the switches 220 while limiting or preventing the risk of tampering with the sensing actuator 202. Additionally, like the anchors 134, 136, 138, the anchors 206, 208, 210 can additionally or alternatively reinforce and stabilize the sensing actuator 202 to limit bowing, bending, or warping in the sensing actuator in use and/or during installation.

A first anchor 206 may be configured similar to the first anchor 134 and may be positioned at or proximate the first end 216 of the mounting bracket 204 to movably connect the first end 212 of the sensing actuator 202 to the first end 216 of the mounting bracket 204. A second anchor 208 may be configured similar to the second anchor 136 and may be positioned at or proximate the second end 218 of the mounting bracket 204 to movably connect the second end 214 of the sensing actuator 202 to the second end 218 of the mounting bracket 204. The first and second anchors 206, 208, like the first and second anchors 134, 136, may provide support to the sensing actuator 202 at or proximate the ends 212, 214.

At least a third anchor 210 is preferably provided, similar to the third anchor 138, to support the sensing actuator 202 along its length between the ends 212, 214. In some embodiments, the third anchor 210 is fixedly attached (e.g., welded) to the sensing actuator 202 in a central or intermediate region of the actuator 202. The third anchor 210 limits the sensing actuator 202 from bowing, bending, or warping between the ends 212, 214, provides more stability to the sensing actuator 202 for well-controlled movement in the vertical direction, and/or limits undesired movement of the sensing actuator 202 in the horizontal direction which can otherwise present a risk of damage to or tampering with the sensing actuator.

The third anchor 210 can also be referred to as a reinforcing anchor. In the illustrated embodiment, a single reinforcing anchor 210 is provided and is located generally toward the center of the mounting bracket 204 for supporting a central region of the sensing actuator 202. In some embodiments, multiple reinforcing anchors can be included for supporting the sensing actuator 202 between the ends 212, 214. For example, the sensor assembly 200 may include two, three, four, five, more than five (such as up to ten), or even more than ten reinforcing anchors. The multiple reinforcing anchors can be spaced apart between the ends 216, 218 of the mounting bracket 204 at regular intervals or irregular intervals.

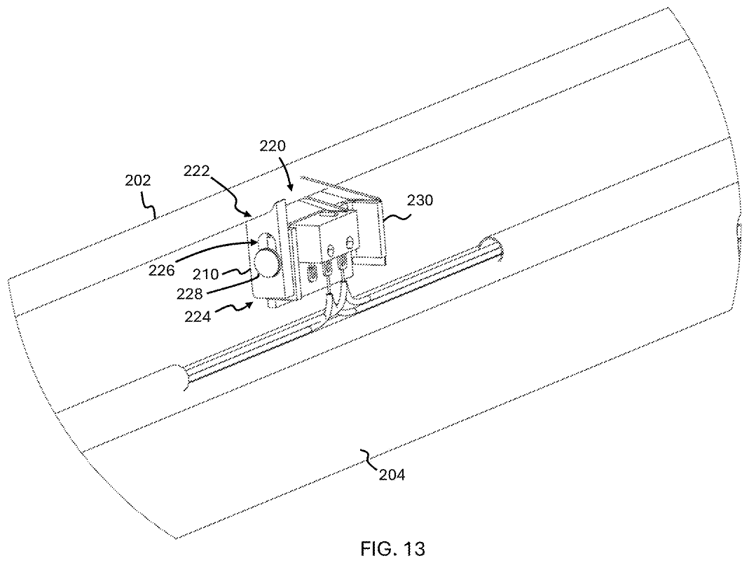

Referring to FIG. 13, the third anchor 210 may include a first anchor end 222 that is fixedly attached (e.g., welded) to the sensing actuator 202 and a second, free anchor end 224 opposite the first anchor end 222. The first anchor end 222 may be contoured or profiled (e.g., concavely shaped) to complement an outer contour or profile of the sensing actuator 202 (e.g., a rounded or cylindrical outer profile). A slot 226 may be defined in a body of the third anchor 210, extending between the first anchor end 222 and the second anchor end 224. The slot 226 may be oval or oblong in shape to allow movement of the sensing actuator 202 relative to a male engagement element 228 that is fixed with the mounting bracket 204.

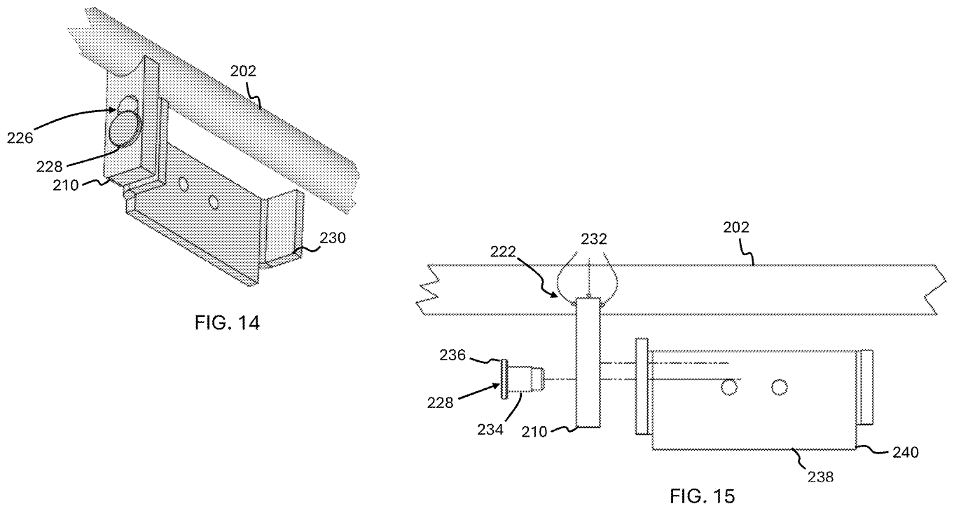

The male engagement element 228, e.g., an engagement pin, may be fixedly connected to a structural support member that in turn is mounted to the mounting bracket 204. In some embodiments, as shown in FIGS. 13 and 14, the male engagement element 228 may be fixedly connected to and may extend laterally from a structural housing 230 of one of the switches 220. For example, the male engagement element 228 may be fixedly connected to a structural housing 230 of a middle one of the switches 220.

Referring to FIGS. 13 and 14, the male engagement element 228 and the slot 226 are preferably sized to allow vertical movement of the third anchor 210 relative to the male engagement element 228 and the structural housing 230, and thereby allow vertical movement of the sensing actuator 202, while limiting or preventing horizontal movement of third anchor 210 relative to the male engagement element 228 in the slot 226, and thereby limiting or preventing horizontal movement of the sensing actuator 202. For example, the male engagement element 228 may be substantially cylindrical in shape and the slot 226 may be oval or oblong in shape, where a vertical height of the slot is sized to allow movement of the sensing actuator 202 between the inactive and active positions, and where a horizontal width of the slot is approximately equal to a diameter of the male engagement element 228.

Referring to FIG. 15, the third anchor 210 can be assembled on the sensing actuator 202 via welding, forming a reliable weld or seam 232 between the sensing actuator 202 and the first anchor end 222. However, other means of fixedly attaching the third anchor 210 to the sensing actuator 202 may be utilized. The male engagement element 228 may include a pin 234 and a stop 236, where the pin 234 is received and extends through the slot 226 (FIGS. 13 and 14) and the stop 236 retains the third anchor 210 on the engagement element 228. The pin 234 may be received and connected to a horizontally-extending wing 238 of the structural housing 230. The wing 238 may extend horizontally outward from a base 240 of the housing 230 that can be fixedly connected to the mounting bracket 204.

Features described above for the sensor assembly 114 are likewise applicable for the sensor assembly 200, and vice versa, unless expressly stated otherwise or the context clearly indicates otherwise. In this regard, any one or more features of the sensor assembly 114 can be combined with any one or more features of the sensor assembly 200 without departing from the scope of the present disclosure. More generally, the description of multiple embodiments does not imply that such embodiments are mutually exclusive; features from different embodiments may be combined unless such combination would be technically infeasible or explicitly contradictory.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, references to “one embodiment” or “an embodiment” of the present disclosure are not intended to be interpreted as excluding the existence of additional embodiments that also incorporate the recited features.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

As used herein, the term “comprising” is considered synonymous with the term “including” for purposes of United States law. Whenever a composition, an element or a group of elements is preceded with the transitional phrase “comprising,” it is understood that the transitional phrases “consisting essentially of,” “consisting of,” “selected from the group consisting of,” or “is” can additionally or alternatively precede the recitation of the composition, element, or elements and vice versa.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for” or “step for” performing a function, it is intended that such elements are to be interpreted under 35 U.S.C. 112(f). However, for any claims containing elements designated in any other manner, it is intended that such elements are not to be interpreted under 35 U.S.C. 112(f).

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A sensor assembly for a door alarm system that detects overhead conditions of a door, the sensor assembly comprising:
a mounting bracket;
a sensing actuator movably coupled to the mounting bracket, the sensing actuator having a first actuator end and a second actuator end, the sensing actuator being movable in a first direction between an inactive position and an active position, the sensor assembly being operable to transmit a signal for triggering an alarm in response to the sensing actuator moving toward the active position; and
a plurality of anchors for movably coupling the sensing actuator to the mounting bracket,
wherein the plurality of anchors allow movement of the sensing actuator in the first direction and constrain the sensing actuator against movement in a second direction different from the first direction,
wherein the plurality of anchors includes a first anchor located proximate the first actuator end, a second anchor located proximate the second actuator end, and a reinforcing anchor positioned between the first and second actuator ends.

2. The sensor assembly of claim 1, wherein the sensing actuator is an elongate rod extending between the first actuator end proximate a first bracket end of the mounting bracket and the second actuator end proximate a second bracket end of the mounting bracket.

3. The sensor assembly of claim 2, wherein the sensing actuator is constructed as a single-piece rod between the first actuator end and the second actuator end.

4. The sensor assembly of claim 3, wherein the reinforcing anchor is fixedly attached to the sensing actuator at an intermediate region of the sensing actuator between the first and second actuator ends.

5. The sensor assembly of claim 1, wherein, when the sensor assembly is installed on the door, the first direction is a vertical direction and the second direction is transverse to the vertical direction.

6. The sensor assembly of claim 5, wherein the second direction is a horizontal direction when the sensor assembly is installed on the door.

7. The sensor assembly of claim 1, wherein the first anchor and the second anchor each comprises an anchoring bracket defining a slot, wherein anchoring pins are connected to the sensing actuator, wherein each anchoring pin is received in the slot of the first anchor or the second anchor, wherein each anchoring pin is movable in the first direction within the respective slot while being constrained against movement in the second direction within the slot.

8. The sensor assembly of claim 1, wherein the reinforcing anchor comprises an anchoring bracket supporting an intermediate region of the sensing actuator between the first actuator end and the second actuator end to limit bowing, bending, and/or warping of the sensing actuator while permitting movement of the sensing actuator in the first direction.

9. The sensor assembly of claim 1, further comprising:
at least one biasing member configured to bias the sensing actuator toward the inactive position; and
a plurality of switches positioned along the mounting bracket and configured to be actuated by movement of the sensing actuator toward the active position to generate an alarm signal.

10. The sensor assembly of claim 1, wherein the sensing actuator comprises a plurality of actuator segments coupled together, and wherein the reinforcing anchor is positioned at an interface between adjacent actuator segments and the reinforcing anchor includes a slot receiving an engagement element that couples the adjacent actuator segments together.

11. A sensor assembly for a door alarm system, the sensor assembly comprising:
a mounting bracket having a first bracket end and a second bracket end;
a unitary, elongate sensing actuator extending between a first actuator end proximate the first bracket end and a second actuator end proximate the second bracket end, the sensing actuator being movable relative to the mounting bracket in a first direction between an inactive position and an active position;
a first anchor positioned for movably connecting the first actuator end to the mounting bracket proximate the first bracket end;
a second anchor positioned for movably connecting the second actuator end to the mounting bracket proximate the second bracket end; and
a reinforcing anchor coupled to the sensing actuator between the first and second actuator ends, the reinforcing anchor being fixedly attached to the sensing actuator,
wherein the reinforcing anchor is movable relative to the mounting bracket in the first direction by movement of the sensing actuator while being configured to constrain the sensing actuator against movement relative to the mounting bracket in a second direction transverse to the first direction.

12. The sensor assembly of claim 11, wherein the reinforcing anchor defines a slot, the sensor assembly further comprising a male engagement element fixed relative to the mounting bracket and received through the slot, wherein the reinforcing anchor is movable relative to the male engagement element in the first direction by movement of the sensing actuator while being constrained against movement relative to the male engagement element in the second direction.

13. The sensor assembly of claim 12, wherein the male engagement element is a fixed to a structural support member mounted to the mounting bracket.

14. The sensor assembly of claim 13, further comprising at least one switch mounted to the mounting bracket, the at least one switch configured to be actuated by movement of the sensing actuator toward the active position to generate an alarm signal, wherein the male engagement element extends from a structural housing of the at least one switch.

15. The sensor assembly of claim 12, wherein the male engagement element comprises a pin received through the slot and a stop configured to retain the reinforcing anchor on the pin.

16. The sensor assembly of claim 12, wherein the slot is oblong and has a vertical dimension sized to permit travel of the sensing actuator between the inactive position and the active position, and a horizontal dimension approximately equal to a diameter of the male engagement element.

17. The sensor assembly of claim 11, wherein the reinforcing anchor is welded to the sensing actuator.

18. A door alarm system comprising:
a door movable between an open position and a closed position within a door frame having a frame header above a top of the door;
a sensor assembly mounted to the door at the top of the door, the sensor assembly including a mounting bracket and a sensing actuator movable relative to the mounting bracket between an inactive position and an active position in response to an item positioned between the sensing actuator and the frame header when the door is closed;
an alarm device in communication with the sensor assembly, movement of the sensing actuator to the active position configured to generate an alarm signal to the alarm device; and
a plurality of anchors for movably coupling the sensing actuator to the mounting bracket,
wherein the plurality of anchors allows movement of the sensing actuator in a first direction between the inactive position and the active position, and wherein the plurality of anchors constrains the sensing actuator against movement in a second direction different from the first direction,
wherein the plurality of anchors includes a reinforcing anchor configured to support an intermediate region of the sensing actuator to limit bowing, bending, and/or warping of the sensing actuator while permitting movement of the sensing actuator in the first direction.

19. The door alarm system of claim 18, wherein the sensing actuator is an elongate rod extending between a first actuator end proximate a first bracket end of the mounting bracket and a second actuator end proximate a second bracket end of the mounting bracket.

20. The door alarm system of claim 19, wherein the sensing actuator is constructed as a single-piece rod between the first actuator end and the second actuator end, wherein the reinforcing anchor is welded to the sensing actuator at the intermediate region of the sensing actuator between the first and second actuator ends.
